(19) United States
(12) Patent Application Publication
(10) Pub. No.: US 2006/0001826 A1
(43) Pub. Date: Jan. 5, 2006

(54) [REFLECTIVE LIQUID CRYSTAL MICRO DISPLAY PANEL]

(76) Inventors: Da-Shuang Kuan, Hsinchu County (TW); Tony Whitehead, Hsinchu City (TW); Chia-Tsung Chan, Taoyuan County (TW); Chia-Te Lin, Chiayi County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,367

(22) Filed: Jul. 5, 2004

(51) Int. Cl. C09K 19/02

(52) U.S. Cl. 349/178

(57) ABSTRACT

A reflective type liquid crystal micro display panel is provided. The display panel comprises, an active component array substrate, a pixel electrode layer, an opposite substrate, a common electrode layer, two inorganic alignment films and a negative dielectric anisotropic liquid crystal layer. The pixel electrode layer is disposed over the active component array substrate. The opposite substrate is opposite to the active component array substrate. The common electrode layer is disposed over the opposite substrate. The two inorganic alignment films are disposed over the pixel electrode layer and the common electrode layer respectively. The negative dielectric anisotropic liquid crystal layer is disposed between the two inorganic alignment films, and is aligned parallel to the inorganic alignment films. The reflective type liquid crystal micro display panel has the advantages of low cost and high performance of display.

### BACKGROUND OF INVENTION

1. Field of the Invention

The present invention relates to a liquid crystal display (LCD) panel. More particularly, the present invention relates to a reflective type liquid crystal micro display panel.

2. Description of Related Art

Recently, liquid crystal display and related technology has been broadly applied in a variety of electronic appliances, such as liquid crystal television, notebook computer, desktop computer or liquid crystal projector. Specially, the liquid crystal projector is developed for large size displaying technology. In general, the micro liquid crystal panel adopted in the liquid crystal projector may be classified into transmission type liquid crystal micro display panel and reflective type liquid crystal micro display panel. The transmission type liquid crystal micro display panel is generally constructed on a glass substrate. The reflective type liquid crystal micro display panel is generally constructed on a silicon substrate. In general, a reflective type liquid crystal micro display panel constructed on a silicon substrate may also be called a liquid crystal on silicon (LCOS) display panel.

In a liquid crystal projector, a light generated from light source is modulated by a micro liquid crystal panel to carry an image, and then scaled and projected on a screen by an optical system. Therefore, the resolution of micro liquid crystal display panel of liquid crystal projector is higher than that of conventional liquid crystal display of computer. In a variety of micro liquid crystal panels, the liquid crystal on silicon (LCOS) display panel constructed on a silicon wafer has the advantages of small single pixel area. Therefore, the liquid crystal on silicon (LCOS) display panel has become the main stream of the micro liquid crystal panel adopted in the liquid crystal projector.

FIG. 1 is a schematic perspective view illustrating a conventional reflective type liquid crystal micro display panel. Referring to FIG. 1, a conventional reflective liquid crystal micro display panel 100 includes a transparent substrate 110, an alignment film 120, a liquid crystal layer 130, another alignment film 140, an electrode layer 150 and a silicon substrate 160. The electrode layer 150 is disposed on the silicon substrate 160, and the electrode layer 150 includes a first electrode 152 and a second electrode 154. The alignment film 140 is disposed on the silicon substrate 160 and covers the electrode layer 150, and the alignment film 120 is disposed on the transparent substrate 110. The liquid crystal layer 130 is disposed between the transparent substrate 110 and the silicon substrate 160, and is aligned by the alignment film 120 and the alignment film 140.

In the conventional technology, the first electrode 152 and the second electrode 154 are disposed on the silicon substrate 160, and thus an electric field E1 is generated. The electric field E1 corresponds to the pattern of the electrodes. When the intensity of the electric field E1 is 0, the liquid crystal molecule of the liquid crystal layer 130 is arranged perpendicular to the silicon substrate 160. However, the change of the intensity of the electric field E1 induces a two-dimensional motion of the liquid crystal molecule of the liquid crystal layer 130. However, in order to reduce the interference between the electric fields to obtain an excellent display effect, the design of patterns of the first electrode 152 and the second electrode 154 is very complex. Therefore, the cost of the reflective liquid crystal micro display panel 100 is increased, and performance of display is not good.

In addition, in the conventional technology, polyimide (PI) is generally used as a material of fabricating the alignment film 120 and the alignment film 140. However, alignment film that contains organic material is vulnerable to structural damage, chemical degradation or decomposition under the influence of light or heat. Therefore, the damage of the alignment film containing organic material adversely influences the arrangement of the liquid crystal molecule of the liquid crystal layer 130. Thus, the performance of display of the reflective liquid crystal micro display panel 100 is reduced.

Therefore, to improve the disadvantages of the conventional reflective liquid crystal micro display panel described above, to reduce the complexity of design of the pattern of the electrode, to reduce the cost and to increase the durability and the reliability of the display panel are important and desirable.

### SUMMARY OF INVENTION

Therefore, the present invention is directed to a reflective type liquid crystal micro display panel for simplifying the fabricating process, reducing the cost, and increasing the durability and the reliability the reflective type liquid crystal micro display panel.

According to one embodiment of the present invention, a reflective type liquid crystal micro display panel is provided. The display panel comprises an active component array substrate, a pixel electrode layer, an opposite substrate, a common electrode layer, two inorganic alignment films and a negative dielectric anisotropic liquid crystal layer. The pixel electrode layer is disposed over the active component array substrate. The opposite substrate is opposite to the active component array substrate. The common electrode layer is disposed over the opposite substrate. The two inorganic alignment films are disposed over the pixel electrode layer and the common electrode layer respectively. The negative dielectric anisotropic liquid crystal layer is disposed between the two inorganic alignment films and is aligned parallel to the inorganic alignment film by the thereof.

In one embodiment of the present invention, the active component array substrate comprises, for example but not limited to, a thin film transistor (TFT) array substrate or a silicon substrate.

In one embodiment of the present invention, the negative dielectric anisotropic liquid crystal layer comprises, for example but not limited to, a ferro-electric liquid crystal layer.

In one embodiment of the present invention, the inorganic alignment film comprises, for example but not limited to, silicon oxide.

In one embodiment of the present invention, the opposite substrate comprises, for example but not limited to, a color filter substrate.

In one embodiment of the present invention, the common electrode layer comprises, for example but not limited to, indium tin oxide (ITO) or indium zinc oxide (IZO).

Accordingly, in the reflective type liquid crystal micro display panel of the present invention, the common electrode layer and the pixel electrode layer are disposed above and below the substrate respectively, and the inorganic alignment films are provided for the alignment of the liquid crystal layer. Therefore, since the two electrode layers are disposed above and below the liquid crystal layer respectively, the design of the layout of the electrode layer is simplified in comparison with the conventional design. Thus, the process time for design the layout of the electrode layer is reduced, and thus the cost is also reduced. In addition, the inorganic alignment film is substantially stable and less vulnerable to structural and chemical damage even under long time operation. Therefore, the durability, the reliability and the performance of display of the reflective type liquid crystal micro display panel are effectively promoted.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a schematic perspective view illustrating a conventional reflective type liquid crystal micro display panel.

FIG. 2 is a cross-sectional view illustrating a reflective type liquid crystal micro display panel according to one embodiment of the present invention.

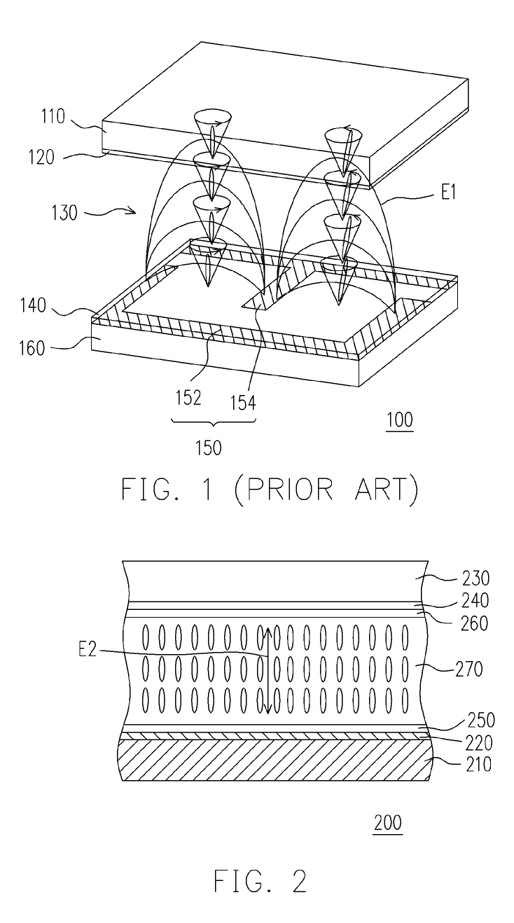

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

FIG. 2 is a cross-sectional view illustrating a reflective liquid crystal micro display panel according to one embodiment of the present invention.

Referring to FIG. 2, a reflective type liquid crystal micro display panel 200 comprises, for example but not limited to, a liquid crystal on silicon (LCOS) display panel. The reflective type liquid crystal micro display panel 200 comprises, for example but mot limited to, an active component array substrate 210, a pixel electrode layer 220, an opposite substrate 230, a common electrode layer 240, two inorganic alignment films 250 and 260 and a negative dielectric anisotropic liquid crystal layer 270.

The pixel electrode layer 220 is disposed over the active component array substrate 210. The opposite substrate 230 is opposite to the active component array substrate 210. The common electrode layer 240 is disposed over the opposite substrate 230. The inorganic alignment films 250 and 260 are disposed over the pixel electrode layer 220 and the common electrode layer 240 respectively. The negative dielectric anisotropic liquid crystal layer 270 is disposed between the two inorganic alignment films, and is aligned parallel to the inorganic alignment films by thereof.

In the present embodiment, the active component array substrate 210 is constructed by, for example but not limited to, forming a plurality of active components (not shown) arranged in array over a silicon wafer by using semiconductor process. The active component comprises, for example but not limited to, thin film transistor (TFT) or complementary metal oxide semiconductor (MOS). The pixel electrode layer 220 comprises, for example but not limited to, a plurality of pixel electrodes electrically connected with the corresponding active components respectively. Therefore, the active components are driven by the corresponding pixel electrodes.

The negative dielectric anisotropic liquid crystal layer 270 comprises, for example but not limited to, a ferro-electric liquid crystal layer. It is noted that the terminals of the liquid crystal molecule of the ferro-electric liquid crystal layer have higher polarities than that of the conventional liquid crystal molecule. Therefore, when the intensity of the electric field applied to the liquid crystal molecule of the ferro-electric liquid crystal layer is changed, the time for twisting is shorter, i.e., response speed is faster. Thus, the response time of the ferro-electric liquid crystal layer is shorter and suitable for commercialization. However, in another embodiment of the invention, the negative dielectric anisotropic liquid crystal layer 270 besides comprising the ferro-electric liquid crystal layer, other type of liquid crystal layer is also included.

The inorganic alignment films 250 and 260 may comprise, for example but not limited to, silicon oxide or other inorganic material. The inorganic alignment films 250 and 260 are hard to be damaged, degraded or decomposed even under long time irradiation or under a high temperature circumstance during the reflective liquid crystal display panel 200 is operated.

The opposite substrate 230 comprises, for example but not limited to, a color filter substrate. Therefore, the light may be filtered and converted into a variety of color lights by the corresponding color filter films of the opposite substrate 230 to generate a color image. In another embodiment of the invention, the opposite substrate 230 not only comprises a color filter substrate, but also may comprise a transparent substrate such as a glass substrate. In the embodiment, the color of the projected image is changed by another optical components of the liquid crystal projector (not shown).

The common electrode layer 240 comprises, for example but not limited to, a transparent conductive material such as indium tin oxide (ITO) or indium zinc oxide (IZO). The pixel electrode layer 220 and common electrode layer 240 are disposed above and below the negative dielectric anisotropic liquid crystal layer 270 respectively. Therefore, the direction of the generated electric field E2 is perpendicular to the active component array substrate 210. Thus, the change of the intensity of the electric field E2 induces a one-dimensional motion of the liquid crystal molecule of the negative dielectric anisotropic liquid crystal layer 270.

Accordingly, in a reflective type liquid crystal micro display panel of the present invention, the common electrode layer and the pixel electrode layer are disposed above and below the substrate respectively, and the inorganic alignment films are provided for the alignment of the liquid crystal layer. Therefore, since the two electrode layers are disposed above and below the liquid crystal layer respectively, the design of the layout of the electrode layer is simplified in comparison with the conventional design. Thus, the process time for design the layout of the electrode layer is reduced, and thus the cost is also reduced. In addition, the inorganic alignment film is more stable and less vulnerable to structural and chemical damage even under long time operation. Therefore, the durability, the reliability and the performance of display of the reflective type liquid crystal micro display panel are effectively promoted.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A reflective type liquid crystal micro display panel, comprising:
an active component array substrate;
a pixel electrode layer, disposed over the active component array substrate;
an opposite substrate, disposed opposite to the active component array substrate;
a common electrode layer, disposed over the opposite substrate;
two inorganic alignment films, disposed over the pixel electrode layer and the common electrode layer respectively; and
a negative dielectric anisotropic liquid crystal layer, disposed between the two inorganic alignment films, and aligned parallel to the inorganic alignment films.

2. The display panel of claim 1, wherein the active component array substrate comprises a thin film transistor (TFT) array substrate.

3. The display panel of claim 1, wherein the active component array substrate comprises a silicon substrate.

4. The display panel of claim 1, wherein the negative dielectric anisotropic liquid crystal layer comprises ferroelectric liquid crystal layer.

5. The display panel of claim 1, wherein a material of the inorganic alignment film comprises silicon oxide.

6. The display panel of claim 1, wherein the opposite substrate comprises a color filter substrate.

7. The display panel of claim 1, wherein a material of the common electrode layer comprises indium tin oxide (ITO) or indium zinc oxide (IZO).
